(19) United States
(12) Patent Application Publication
(10) Pub. No.: US 2019/0302769 A1
(43) Pub. Date: Oct. 3, 2019

(54) DETOUR DETERMINATION DEVICE, DETOUR DETERMINATION METHOD, AND NON-TRANSITORY COMPUTER READABLE MEDIUM

(71) Applicant: Panasonic Intellectual Property Management Co., Ltd., Osaka (JP)

(72) Inventors: Shota NAKAMURA, Kanagawa (JP); Takao NIHEI, Kanagawa (JP)

(73) Assignee: PANASONIC INTELLECTUAL PROPERTY MANAGEMENT CO., LTD., Osaka (JP)

(21) Appl. No.: 16/361,829

(22) Filed: Mar. 22, 2019

(30) Foreign Application Priority Data
Mar. 29, 2018 (JP) 2018-066231

(51) Int. Cl. G05D 1/00; G01C 21/34; G05D 1/02

(52) U.S. Cl. CPC G05D 1/0088; G01C 21/3415; G05D 2201/0213; G01C 21/3492; G05D 1/0287

(57) ABSTRACT

A detour determination device includes: a detector; an acquirer; a communicator; and a determiner. The determiner, in operation, detects whether another vehicle exists on a route to a destination. The acquirer, in operation, acquires travelling information of a host vehicle. The communicator, in operation, transmits the travelling information of the host vehicle to the another vehicle and receives travelling information from the another vehicle, when the another vehicle exists. The determiner, in operation, determines necessity of detouring of the host vehicle in accordance with the travelling information of the host vehicle and the received travelling information of the another vehicle.

### FIELD

The present disclosure relates to a detour determination device, a detour determination method and a non-transitory computer readable medium.

### BACKGROUND

When two vehicles capable of automated driving encounter at an intersection (for example, a T-shaped road, a Y-shaped road, and the like) where roads having a narrow width to the extent of allowing only one vehicle to travel intersect each other, one of the two vehicles takes a detour and the other travels on the road as planned.

JP-A-2017-204151 has disclosed that, in a parking management system for guiding a vehicle equipped with an automated driving system from a getting on and off space to a predetermined parking space, it is determined whether the vehicle is made to wait or detour when another vehicle exists on the shortest route.

### SUMMARY

However, in a configuration of JP-A-2017-204151, the parking management system does not consider detouring the other vehicle existing on the shortest route and determines whether to make a detour in consideration of a guide target vehicle. This configuration is applied to a case where two vehicles capable of automated driving encounter at an intersection (for example, a T-shaped road) where roads having a narrow width to the extent of allowing only one vehicle to travel as described above intersect each other. In this case, since it is determined whether to take a detour or to travel as planned considering one of the two vehicles, a material (item) used for the determination may be insufficient. Therefore, the accuracy of the determination becomes insufficient, and thus there is a room for improvement on an adaptive determination in accordance with circumstances of the road.

The present disclosure has been made in view of the above-described circumstances, and an object thereof is to provide a detour determination device, a detour determination method, and a non-transitory computer readable medium, which support smooth travelling of two vehicles by making the two vehicles on a road having a narrow width determine whether to take a detour or to travel as planned.

The present disclosure provides a detour determination device including: a a detector, which, in operation, detects whether another vehicle exists on a route to a destination; an acquirer, which in operation, acquires travelling information of a host vehicle; a communicator, which, in operation, transmits the travelling information of the host vehicle to the another vehicle and receives travelling information from the another vehicle, when the another vehicle exists; and a determiner, which, in operation, determines necessity of detouring of the host vehicle in accordance with the travelling information of the host vehicle and the received travelling information of the another vehicle.

The present disclosure provides a detour determination method for a detour determination device, including: detecting whether another vehicle exists on a route to a destination; acquiring travelling information of a host vehicle; transmitting the travelling information of the host vehicle to the another vehicle and receiving travelling information from the another vehicle, when the another vehicle exists; and determining necessity of detouring of the host vehicle in accordance with the travelling information of the host vehicle and the received travelling information of the another vehicle.

The present disclosure provides a non-transitory computer readable medium having a set of computer readable instruction that, when executed, cause an electronic device: detect whether another vehicle exists on a route to a destination; acquire travelling information of a host vehicle; transmit the travelling information of the host vehicle to the another vehicle and receive travelling information from the another vehicle, when the another vehicle exists; and determine necessity of detouring of the host vehicle in accordance with the travelling information of the host vehicle and the received travelling information of the another vehicle.

Arbitrary combinations of the constituent elements described above and those obtained by converting the expressions of the present disclosure among methods, devices, systems, recording media (non-transitory computer readable media), computer programs, and the likes are also effective as aspects of the present disclosure.

According to the present disclosure, it is possible to support smooth travelling of two vehicles by making the two vehicles on a road having a narrow width determine whether to take a detour or to travel as planned.

### BRIEF DESCRIPTION OF DRAWINGS

FIG. 1 is a block diagram illustrating an internal configuration example of each of a vehicle and another vehicle equipped with a detour determination device according to Embodiment 1;

FIG. 2 is an explanatory view illustrating an example of a positional situation between the vehicle and the other vehicle according to each embodiment;

FIG. 3 is a flowchart for explaining an example of an operation procedure of the vehicle equipped with the detour determination device according to Embodiment 1;

FIG. 4 is a flowchart for explaining an example of an operation procedure of the vehicle equipped with a detour determination device according to Embodiment 2-1;

FIG. 5 is a flowchart for explaining a subroutine of priority degree assignment processing PR2-1 in Step St9 of FIG. 4;

FIG. 6 is a flowchart for explaining a subroutine of priority degree assignment processing PR1 in Step St9-1 of FIG. 5;

FIG. 7 is a flowchart for explaining an example of an operation procedure of the vehicle equipped with a detour determination device according to Embodiment 2-2;

FIG. 8 is a flowchart for explaining a subroutine of priority degree assignment processing PR2-2 in Step St10 of FIG. 7;

FIG. 9 is a block diagram for illustrating an internal configuration example of each of the vehicle and the other vehicle equipped with a detour determination device according to Embodiment 3;

FIG. 10 is a flowchart for explaining an example of an operation procedure of the vehicle equipped with the detour determination device according to Embodiment 3;

FIG. 11 is a flowchart for explaining an example of an operation procedure of the vehicle equipped with the detour determination device according to Embodiment 3; and

FIG. 12 is a flowchart for explaining a subroutine of priority degree assignment processing PR3 in Step St13 of FIG. 11.

### DETAILED DESCRIPTION

Hereinafter, each embodiment specifically disclosing a detour determination device, a detour determination method, and a program therefor according to the present disclosure will be described in detail with reference to the accompanying drawings as appropriate. However, a more detailed description than necessary may be omitted. For example, detailed descriptions of well-known matters or redundant explanations for substantially the same constitution may be omitted. This is to avoid the following description from becoming unnecessarily redundant and to facilitate understanding by those skilled in the art. Further, the accompanying drawings and the following description are provided to enable those skilled in the art to sufficiently understand the present disclosure and are not intended to limit the subject matter recited in the claims.

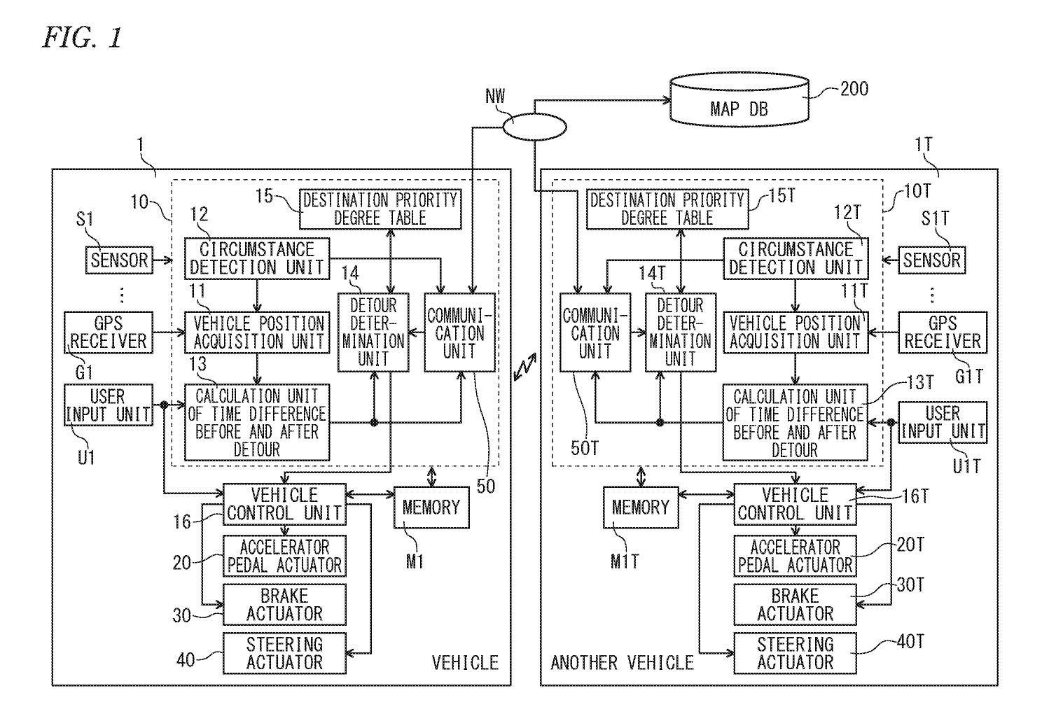

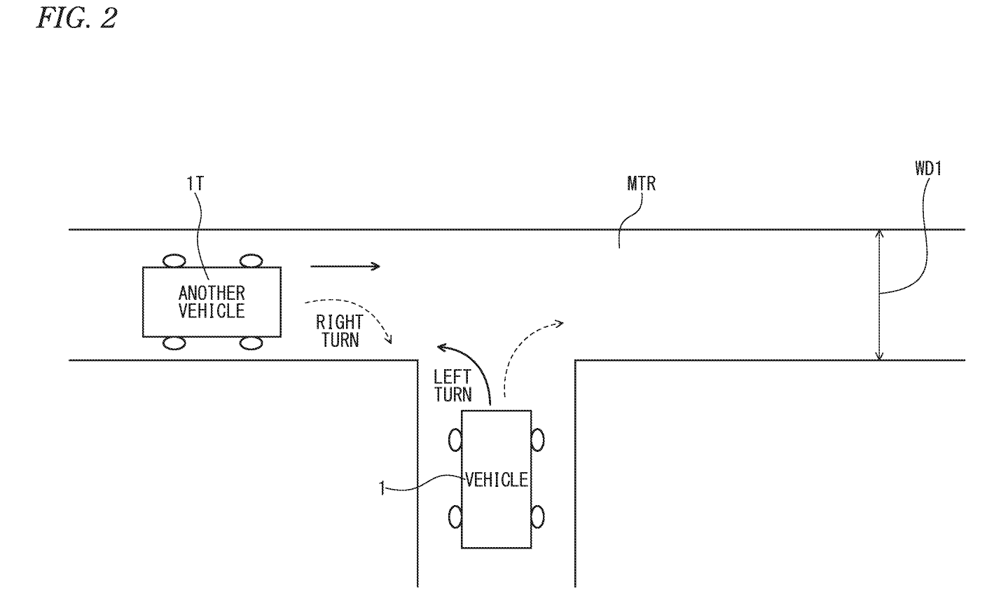

In each of the following embodiments, the detour determination devices are mounted on a vehicle and another vehicle (see FIGS. 1 and 2) which have a driving automation level of 1 or more, for example. Hereinafter, in order to explain the contents of each embodiment in an easy-to-understand manner, automated driving vehicles capable of automated driving with a driving automation level of 3 will be described as an example of the vehicle and the another vehicle equipped with the detour determination device. In each embodiment, the vehicle (host vehicle) encounters the another vehicle on a narrow road with a width of one vehicle during automated driving. A T-shaped road will be exemplified and explained as an example of the road with the encounter. Further, as an example of the road, a Y-shaped road or a road having another shape may be used as long as it has a width of one vehicle.

### Embodiment 1

In Embodiment 1, a vehicle 1 encounter another vehicle 1T on a narrow road (for example, a T-shaped road, hereinafter referred to as a “narrow road” for the convenience of explanation) having a width of only one vehicle during automated driving. The another vehicle 1T also has the same configuration as that of the vehicle 1 (see FIG. 1). Described is an example where, when the vehicle detects the encounter on the narrow road described above, the vehicle 1 transmits and receives information on time difference before and after a detour (see below) with the another vehicle 1T by inter-vehicle communication and decides whether to take a detour or proceed as planned according to the extent of time difference before and after a detour.

FIG. 1 is a block diagram illustrating an internal configuration example of each of the vehicle 1 and the another vehicle 1T on which detour determination devices 10 and 10T according to Embodiment 1 are mounted. FIG. 2 is an explanatory diagram illustrating an example of a positional situation between the vehicle 1 and the another vehicle 1T according to each embodiment.

As illustrated in FIG. 2, there is a possibility that the vehicle 1 may encounter the another vehicle 1T on a narrow road MTR having a width WD1 of only one vehicle during automated driving. In this case, according to a determination result of the necessity of a detour in the detour determination device 10 described below, the vehicle 1 takes (for example, turn right at a T-junction of the narrow road MTR in FIG. 2) a detour and proceeds to a destination of the vehicle 1 or proceeds (for example, turn left at the T-junction of the narrow road MTR in FIG. 2) as planned without making a detour and proceeds to the destination of the vehicle 1. In an example of FIG. 2, when the vehicle 1 takes a detour, the vehicle 1 starts detouring (that is, turning right at the T-junction) before the another vehicle 1T makes a right turn.

On the contrary, according to a determination result of the necessity of a detour in the detour determination device 10T described below, the another vehicle 1T takes (for example, go straight at the T-junction of the narrow road MTR in FIG. 2) a detour and proceeds to a destination of the another vehicle 1T or proceeds (for example, turn right at the T-junction of the narrow road MTR in FIG. 2) as planned without making a detour and proceeds to the destination of the another vehicle 1T. In the example of FIG. 2, when the another vehicle 1T takes a detour, the another vehicle 1T starts detouring (that is, going straight at the T-junction) before the vehicle 1 makes a left turn.

Therefore, in Embodiment 1, when the vehicle 1 takes a detour, the another vehicle 1T proceeds as planned without making a detour and, on the contrary, when the vehicle 1 does not take a detour and proceeds as planned, the another vehicle 1T takes a detour. Thus, the vehicle 1 and the another vehicle 1T do not collide with each other and smoothly travel by automated driving even when the vehicle 1 encounters the another vehicle 1T.

As describe above, the vehicle 1 and the another vehicle 1T have the same configuration. Therefore, in the following description, for easy understanding of the description, the configuration of the vehicle 1 will be mainly described and the configuration of the another vehicle 1T will be described as necessary. Further, it is possible to describe the another vehicle 1T by replacing each configuration of the vehicle 1 with each corresponding configuration of the another vehicle 1T.

The vehicle 1 has a configuration including a plurality of sensors S1, a GPS receiver G1, a user input unit U1, the detour determination device 10, a vehicle control unit 16, an accelerator pedal actuator 20, a brake actuator 30, a steering actuator 40, a communication unit 50, and a memory M1. The vehicle 1 is communicably connected to a map database 200 via a network NW.

The another vehicle 1T has a configuration including a plurality of sensors S1T, a GPS receiver G1T, a user input unit U1T, the detour determination device 10T, a vehicle control unit 16T, an accelerator pedal actuator 20T, a brake actuator 30T, a steering actuator 40T, a communication unit 50T, and a memory M1T. The another vehicle 1T is connected so as to be able to communicate with the map database 200 via the network NW.

The map database 200 is a recording device for storing map information including information on a travelling road and the topography necessary for the vehicle 1 to perform automated driving and is connected to be able to communicate with the vehicle 1 and the another vehicle 1T via the network NW. The map database 200 holds periodically updated map information (for example, a dynamic map in which information on real-time road traffic conditions is added to static map information). The map database 200 may be recorded in the vehicle 1 in advance or may be recorded in a car navigation device (not illustrated) mounted on the vehicle 1. In FIG. 1, the map database is referred to as a “map DB” for the sake of convenience.

Next, each configuration of the vehicle 1 will be described in detail.

Each of the plurality of sensors S1 detects the circumstances around the vehicle 1 and outputs the information of the detection result (that is, the travelling information of the vehicle 1) to the detour determination device 10. The travelling information is, for example, a travelling direction of the vehicle 1 and a vehicle speed. Each sensor S1 may include, for example, a camera, an around view camera, a radar and a plurality of laser range finders. The sensor is not limited to any one of the camera, the around view camera, the radar, and the plurality of laser range finders and may include, for example, a gyro sensor, an acceleration sensor, a geomagnetic sensor, an inclination sensor, an air temperature sensor, a barometric pressure sensor, a humidity sensor and an illuminance sensor.

A camera as an example of the sensor has an imaging element such as a Charge Coupled Device (CCD) or Complementary Metal Oxide Semiconductor (CMOS). The camera is installed, for example, at the center of a front part of a vehicle body of the vehicle 1 and images an area in the front center as a detection range. Specifically, the camera detects obstacles (for example, another vehicle, a two-wheeled vehicle, a bicycle, a pedestrian and the like, hereinafter the same applies) or the like existing in front of the vehicle 1. The camera can execute image processing using data of the captured image. The camera can detect a position and a travelling direction of the obstacle with reference to the position of the vehicle 1 by image processing.

The around view camera as an example of the sensor is constituted by using a plurality of cameras (for example, six cameras in total, two cameras at the front of the vehicle body, two cameras at the rear of the vehicle body, and two cameras at the side of the vehicle body) installed respectively at the front, the rear and the side of the vehicle body of the vehicle 1. The around view camera detects a pedestrian in the vicinity of the vehicle 1, a white line, another vehicle on an adjacent lane, and the like.

A radar as an example of the sensor is constituted by using a radars plurality (for example, two) installed respectively in the front and the rear of the vehicle body of the vehicle 1. The radar may be installed only in the front of the vehicle body of the vehicle 1. The radar is constituted by using, for example, a millimeter wave radar, a sonar radar, a Light Detection and Ranging, Laser Imaging Detection and Ranging (LiDAR). The radar irradiates an ultrasonic wave or an electromagnetic wave such as a millimeter wave while performing scanning in a limited angular range, receives a reflected light beam, and detects a time difference between the start time point of irradiation and the reception time point of the reflected light beam to detect a distance between the host vehicle and the obstacle, and furthermore, a direction of the obstacle when viewed from the host vehicle.

The laser range finders as an example of the sensor are installed respectively on the front right side, the front left side, the lateral right side, the lateral left side, the rear right side, and the rear left side of the vehicle body of the vehicle 1. The laser range finders respectively detect obstacles (see above) and the likes existing on the front right side, the front left side, the lateral right side, the lateral left side, the rear right side, and the rear left side of the vehicle 1. Specifically, the laser range finders respectively irradiate laser beams while performing scanning in a certain wide angular range, receive reflected light beams, and detect a time difference between the start time point of irradiation and the reception time point of the reflected light beams to detect a distance between the vehicle 1 and the obstacle, and furthermore, a direction of the obstacle when viewed from the vehicle 1.

The GPS receiver G1 receives a plurality of signals indicating the time and the position of each Global Positioning System (GPS) satellite (that is, three-dimensional coordinate) which have been transmitted from a plurality of GPS satellites and calculates the position of the GPS receiver G1 (that is, the current position of the vehicle 1) based on the plurality of received signals. The GPS receiver G1 outputs the information on the current position of the vehicle 1 to a vehicle position acquisition unit 11 of the determination device 10.

The user input unit U1 is a device through which a user (for example, a driver or a passenger of the vehicle 1) can input various data or information and accepts, for example, a user's operation on a destination setting screen (not illustrated) displayed on a Human Machine Interface (HMI, not illustrated) which is mounted in the vehicle 1. The user input unit U1 outputs the information input by the instruction of a user (for example, the information on the destination) to a calculation unit of time difference before and after a detour 13 of the detour determination device 10.

The detour determination device 10 is an automated driving controller (so-called ADAS: Advanced Driver-Assistance Systems) which is mounted in the vehicle 1 and equipped with a control function during automated driving of driving automation level 1 or more of the vehicle 1 and determines the behavior of the vehicle 1 in the automated driving. The detour determination device 10 realizes automated driving of the vehicle 1 by controlling operations of the accelerator pedal actuator 20, the brake actuator 30 and the steering actuator 40 via the vehicle control unit 16 based on various data or information input or provided from the plurality of sensors S1, the GPS receiver G1 and the map database 200.

Automated driving of the vehicle 1 is, for example, a function to stop the vehicle 1 by operating a brake immediately before the vehicle 1 is likely to collide with the obstacles (see above) such as other vehicles, a function to follow another vehicle running in front of the vehicle 1 while maintaining a certain distance, and a function to control a steering of the vehicle 1 so as not to deviate from a lane. However, those functions are only a limited list and the automated driving is not limited to those functions.

The detour determination device 10 includes the vehicle position acquisition unit 11, a circumstance detection unit 12, the calculation unit of time difference before and after a detour 13, a detour determination unit 14 and a destination priority degree table 15. Similarly, the detour determination device 10T includes a vehicle position acquisition unit 11T, a circumstance detection unit 12T, a calculation unit of time difference before and after a detour 13T, a detour determination unit 14T and a destination priority degree table 15T.

The vehicle position acquisition unit 11, the circumstance detection unit 12, the calculation unit of time difference before and after a detour 13 and the detour determination unit 14 are constituted by using, for example, a single or separate Electronic Control Units (ECUs) mounted on the vehicle 1. That is, the vehicle position acquisition unit 11, the circumstance detection unit 12, the calculation unit of time difference before and after a detour 13 and the detour determination unit 14 can be functionally concretely realized by being executed by the electronic control unit in cooperation with the memory M1 by referring to the program and data stored in the memory M1.

The vehicle position acquisition unit 11 inputs and acquires information on the current position of the vehicle 1 during automated driving which is calculated by the GPS receiver G1. When the vehicle position acquisition unit 11 acquires information indicating that encounter with the another vehicle 1T on the narrow road is detected from the circumstance detection unit 12, the vehicle position acquisition unit 11 outputs the information on the current position of the vehicle 1 during automated driving to the calculation unit of time difference before and after a detour 13.

The circumstance detection unit 12 as an example of the detection unit detects environmental information of the surroundings of the vehicle 1 during automated driving and whether encounter with the another vehicle 1T occurs on the narrow road during automated driving of the vehicle 1, based on the information on the detection results of the plurality of sensors S1. The circumstance detection unit 12 outputs information on various kinds of detection results (for example, a detection result on the presence of encounter with the another vehicle 1T) to the vehicle position acquisition unit 11 and the communication unit 50.

The calculation unit of time difference before and after a detour 13 as an example of the acquisition unit inputs and acquires the information on the destination of the vehicle 1 which is output from the user input unit U1 and the information on the current position of the vehicle 1 which is output from the vehicle position acquisition unit 11. The calculation unit of time difference before and after a detour 13 calculates, using the detection results from the plurality of sensors S1, a time difference before and after a detour indicating a difference between a first required time in a case in which the vehicle 1 (host vehicle) travels from the narrow road where the vehicle 1 encounters the another vehicle 1T to the destination of the vehicle 1 with detouring and a second required time in a case in which the vehicle 1 proceeds to the destination as planned without detouring as travelling information of the vehicle 1. The calculation unit of time difference before and after a detour 13 outputs the information on the calculated time difference before and after a detour to the detour determination unit 14 and the communication unit 50.

When the detour determination unit 14 acquires the information indicating that encounter with the another vehicle 1T on the narrow road is detected from the circumstance detection unit 12, the detour determination unit 14 as an example of the determination unit determines whether it is necessary for the vehicle 1 to take a detour on the narrow road in accordance with the information on the time difference before and after a detour of the vehicle 1 output from the calculation unit of time difference before and after a detour 13 and the information on the time difference before and after a detour of the another vehicle 1T output from the communication unit 50. The detour determination unit 14 outputs, to the vehicle control unit 16, an instruction to execute automated driving according to the result of determination on the necessity of detour of the vehicle 1 on the narrow road.

Further, the detour determination unit 14 may consider not only a comparison between the time difference before and after a detour of the vehicle 1 and the time difference before and after a detour of the another vehicle 1T but also the priority degree according to the destination of the vehicle 1 by referring to the destination priority degree table 15 to determine whether it is necessary for the vehicle 1 to take a detour on the narrow road.

The destination priority degree table 15 holds the priority degree (that is, a value of a priority type which is a parameter for determining whether to take a detour when the vehicle 1 encounters the another vehicle 1T on the narrow road) according to the destination of the vehicle 1 specified by the user input unit U1. For example, in the destination priority degree table 15, the priority degree (specifically, the value of the priority type) is the highest at “5” when the destination is a hospital and the priority degree is the next highest at “3” when the destination is a company, and further, the priority degree is the next higher at “2” when the destination is a department store. In this way, the destination and the priority degree are defined in association with each other.

The vehicle control unit 16 includes, for example, an automated driving controller (not illustrated) which implements a control function during automated driving of the driving automation level 1 or more of the vehicle 1. Specifically, the vehicle control unit 16 applies a control command input from the Human Machine Interface (HMI, not illustrated) of a user such as a driver and various pieces of information collected from each of the plurality of sensors S1 to a predetermined automated driving algorithm. Therefore, the vehicle control unit 16 calculates control values for controlling control target devices necessary for automated driving, such as an accelerator throttle opening degree of the vehicle 1, a braking force of the vehicle 1 and a steering angle.

The control values are calculated to travel according to a travelling route (that is, a travelling path to a destination designated by an operation on the HMI by a user) generated by, for example, a route generation unit (not illustrated) included in the automated driving controller. The travelling route is calculated and generated by the route generation unit (not illustrated) and is input to the vehicle control unit 16. The vehicle control unit 16 transmits the calculated control values to the actuators (that is, the accelerator pedal actuator 20, the brake actuator 30 and the steering actuator 40) for driving the respective control targets for example, a steering wheel, an accelerator pedal and a brake) or a blinker controller (not illustrated).

The vehicle control unit 16 acquires an execution instruction output from the detour determination device 10. The vehicle control unit 16 executes the operation determined by the detour determination device 10 (that is, travelling with detouring the narrow road or proceeding as planned without detouring the narrow road) by controlling the operations of the accelerator pedal actuator 20, the brake actuator 30, the steering actuator 40 and the blinker controller (not illustrated) based on the execution instruction. Therefore, when the vehicle 1 encounters the another vehicle 1T on the narrow road, the vehicle 1 can promptly adaptively determine whether to take a detour or to proceed as planned without detouring according to the extent of the respective time differences before and after a detour of the vehicle 1 and the another vehicle 1T which exist on the narrow road. As a result, the vehicle 1 can smoothly proceed on the narrow road.

The accelerator pedal actuator 20 controls the operation of the accelerator pedal (in other words, maintaining or increasing/decreasing the vehicle speed of the vehicle 1) during automated driving in accordance with, for example, a control signal of the accelerator pedal (not illustrated) input from the vehicle control unit 16.

The brake actuator 30 controls the operation of the brake (in other words, maintaining or changing the braking of the vehicle 1) during automated driving in accordance with, for example, a control signal of the brake pedal (not illustrated) input from the vehicle control unit 16.

The steering actuator 40 controls the operation of the steering wheel (in other words, maintaining or changing a travelling direction of the vehicle 1) during automated driving in accordance with, for example, a control signal of the steering wheel (not illustrated) input from the vehicle control unit 16.

The communication unit 50 is connected to the map database 200 to be capable of wired or wireless communication and is constituted by using a communication circuit which performs wireless inter-vehicle communication with the another vehicle 1T. When the communication unit 50 acquires the information indicating that encounter with the another vehicle 1T on the narrow road is detected from the circumstance detection unit 12, the communication unit 50 transmits the information on the time difference before and after a detour of the vehicle 1 output from the calculation unit of time difference before and after a detour 13 to the another vehicle 1T. In addition, similarly in the another vehicle 1T, the communication unit 50 receives the information on the time difference before and after a detour (that is, the time difference before and after a detour in the another vehicle 1T) calculated in the another vehicle 1T and outputs the information to the detour determination unit 14.

The memory M1 is constituted by using, for example, a Random Access Memory (RAM) and a Read Only Memory (ROM) and temporarily holds programs and data necessary for executing respective operations of the detour determination device 10 and the vehicle control unit 16, and furthermore, data or information generated during operation. The RAM is a work memory which is used, for example, during operations of the detour determination device 10 and the vehicle control unit 16. The ROM stores and holds, for example, the programs and data for controlling the detour determination device 10 and the vehicle control unit 16 in advance.

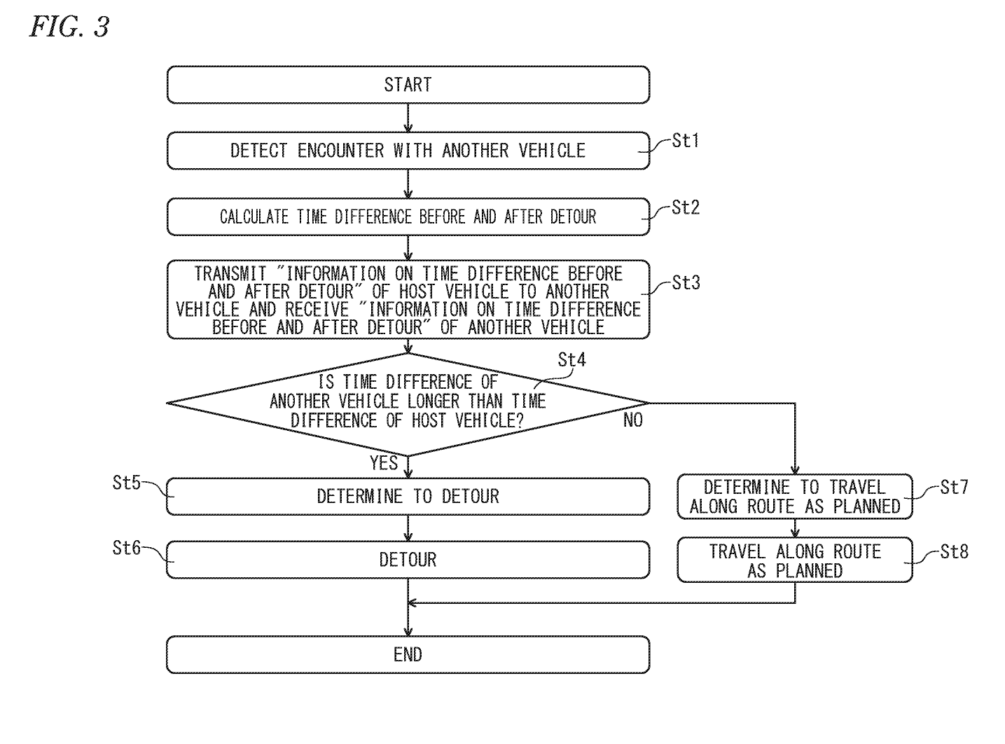

Next, an operation procedure for determining the necessity of detouring when the vehicle 1 equipped with the detour determination device 10 according to Embodiment 1 encounters the another vehicle 1T on the narrow road will be described with reference to FIG. 3. FIG. 3 is a flowchart explaining an example of the operation procedure of the vehicle 1 equipped with the detour determination device 10 according to Embodiment 1. The following operation procedure illustrated in FIG. 3 will be described as the operation of the vehicle 1. However, the operation illustrated in FIG. 3 is also executed in the another vehicle 1T which has the same configuration as the vehicle 1 as described above.

In FIG. 3, the circumstance detection unit 12 in the vehicle 1 detects encounter with the another vehicle 1T on the narrow road MTR illustrated in FIG. 2 based on the information on the detection result of each of the plurality of sensors S1 (St1). In the vehicle 1, after encounter with the another vehicle 1T on the narrow road MTR is detected in Step St1, the calculation unit of time difference before and after a detour 13 calculates the time difference before and after a detour indicating the difference between the first required time in a case in which the vehicle 1 travels from the narrow road where the vehicle 1 encounters the another vehicle 1T to the destination of the vehicle 1 (host vehicle) with detouring and the second required time in a case in which the vehicle 1 proceeds to the destination as planned without detouring as the travelling information of the vehicle 1 (St2). Although detailed description is omitted, the same processing as Step St2 is executed also in the another vehicle 1T and the time difference before and after a detour in the another vehicle 1T is calculated.

The vehicle 1 transmits the information on the time difference before and after a detour in vehicle 1 calculated in Step St2 to the another vehicle 1T through the inter-vehicle communication in the communication unit 50. Further, the vehicle 1 receives the information on the time difference before and after a detour in the another vehicle 1T transmitted from the another vehicle 1T through the inter-vehicle communication by using the communication unit 50 (St3).

In the vehicle 1, the detour determination unit 14 determines whether the time difference before and after a detour in the another vehicle 1T is longer than that in the vehicle 1 (host vehicle) by comparing the time difference before and after a detour in the vehicle 1 with the time difference before and after a detour in the another vehicle 1T (St4).

In the vehicle 1, when it is determined that the time difference before and after a detour in the another vehicle 1T is longer (St4, YES), the detour determination unit 14 determines to take a detour (that is, in order to take a detour, the vehicle 1 travels to the destination with changing the travelling route which is set in advance in the automated driving) (St5). Based on the execution instruction of the automated driving according to the determination of Step St5, the vehicle 1 carries out detour travelling using the vehicle control unit 16 (St6).

When it is determined that the time difference before and after a detour in vehicle 1 is longer (St4, NO), the detour determination unit 14 of the vehicle 1 determines that the vehicle 1 travels along a route as planned without detouring (that is, the vehicle 1 travels to the destination without changing the travelling route which is set in advance in the automated driving) (St7). Based on the execution instruction of the automated driving according to the determination of Step St7, the vehicle 1 travels along the route as planned by using the vehicle control unit 16 (St8).

As described above, in the detour determination device 10 or the vehicle 1 according to Embodiment 1, the circumstance detection unit 12 detects the presence of the another vehicle 1T (for example, encounter with the another vehicle 1T) on the road having the width of one vehicle during automated driving (that is, narrow road MTR) on the route to the destination and the calculation unit of time difference before and after a detour 13 acquires the travelling information of the vehicle 1 (host vehicle). In the detour determination device 10 or the vehicle 1, transmission and reception (for example, inter-vehicle communication) of the travelling information between the vehicle 1 (host vehicle) and the another vehicle 1T are performed in the communication unit 50 when the another vehicle 1T exists (for example, encounter with the another vehicle 1T occurs) and the detour determination unit 14 determines whether it is necessary for the vehicle 1 to take a detour on the narrow road MTR in accordance with the travelling information of the vehicle 1 (host vehicle) and the travelling information of the another vehicle 1T.

Therefore, in the detour determination device 10 or the vehicle 1 according to Embodiment 1, when two vehicles (the vehicle 1, the another vehicle 1T) encounter with each other on a narrow road having a travelling width of, for example, only one vehicle on the route to the destination, calculation of the difference value between travelling information in the case of detouring and travelling information in the case of not detouring can be performed in each vehicle (the vehicle 1, the another vehicle 1T) and the difference value can be transmitted and received by the inter-vehicle communication. Therefore, the detour determination device 10 or the vehicle 1 can adaptively determine whether to take a detour or to travel as planned in accordance with the circumstance of the road (for example, travelling information from the positions of the vehicles to the destinations thereof) and support smooth travelling of both vehicles.

The detour determination device 10 outputs a travelling instruction by automated driving based on the determination result of the necessity of detouring on the narrow road MTR to the vehicle control unit 16 for controlling the operation of the vehicle 1 (host vehicle). As a result, when the vehicle 1 proceeds on the narrow road MTR where the vehicle 1 encounters the another vehicle 1T, the vehicle 1 can avoid a collision with the another vehicle 1T and quickly travel along a route with detouring or as planned. Thus, even when the vehicle 1 encounters the another vehicle 1T, the vehicle 1 can proceed smoothly and safely.

The detour determination device 10 calculates the time difference before and after a detour indicating the difference between the first required time to travel from the narrow road MTR to the destination of the vehicle 1 (host vehicle) with detouring and the second required time to proceed to the destination without detouring as the travelling information of the vehicle I (host vehicle). The detour determination device 10 transmits the travelling information of the vehicle 1 (host vehicle) including the information on the time difference before and after a detour of the vehicle 1 (host vehicle) (an example of a detouring time difference) to the another vehicle 1T and receives the travelling information of the another vehicle 1T including the information on the time difference before and after a detour of the another vehicle 1T. The detour determination device 10 determines the necessity of detouring on the narrow road MTR in accordance with the time difference before and after a detour of the vehicle 1 (host vehicle) and the time difference before and after a detour of the another vehicle 1T.

Therefore, calculation of the difference value between a required time until the arrival at the destination with detouring and a required time until the arrival at the destination by proceeding as planned without detouring is performed in each vehicle (the vehicle 1, the another vehicle 1T) and the vehicle 1 can transmit and receive the information on the time difference before and after a detour by the inter-vehicle communication. Thus, the vehicle can adaptively determine whether to take a detour or to travel as planned in accordance with the circumstance of the road (for example, the required time difference until the arrival at the destinations of the vehicles from the positions thereof) and when it takes a lot more time to detour, the detour is avoided, thereby supporting smooth travelling of both vehicles.

### Embodiment 2-1

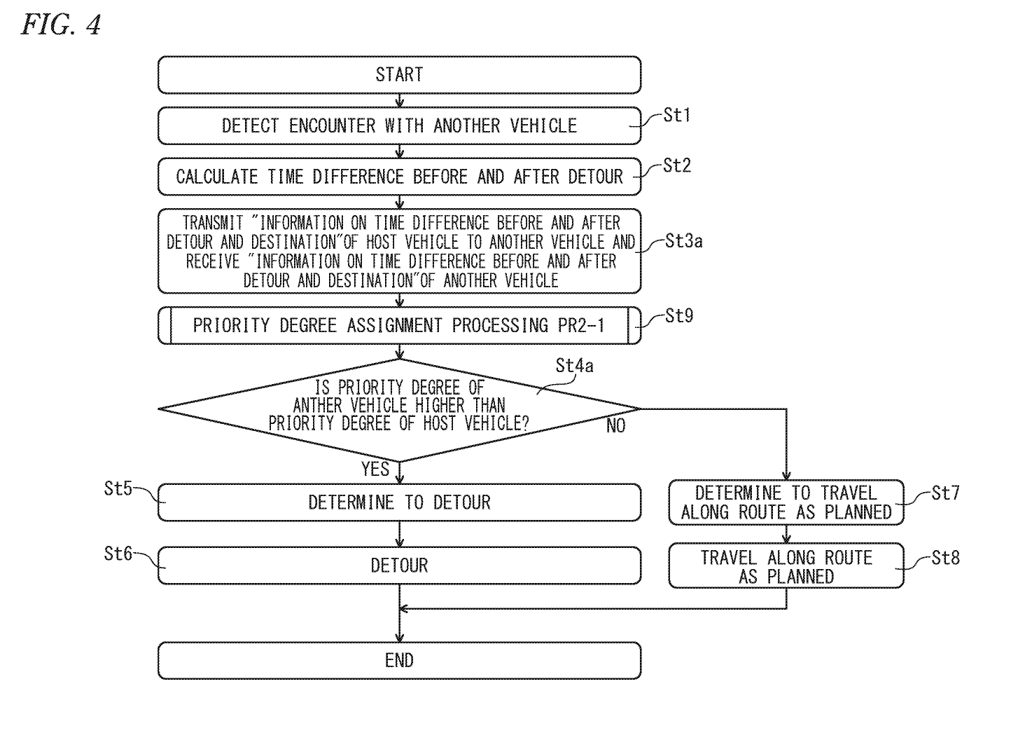

As similar in Embodiment 1, also in Embodiment 2-1, the vehicle 1 encounters the another vehicle 1T on a narrow road during automated driving. Described is an example in which, when the vehicle 1 detects the encounter on the narrow road, the vehicle 1 transmits and receives information on the time difference before and after a detour and the destination to and from the another vehicle 1T by the inter-vehicle communication and determines whether to take a detour or to proceed as planned in accordance with the magnitude of the sum of the priority degrees respectively corresponding to the time differences before and after a detour and the destinations (see FIG. 4).

The internal configurations of the vehicle 1 and the another vehicle 1T according to Embodiment 2-1 are the same as those of the vehicle 1 and the another vehicle 1T according to Embodiment 1. Thus, the same reference signs are denoted to the same components, the description of the same contents is simplified or omitted, and different contents will be described.

FIG. 4 is a flowchart explaining an example of an operation procedure of the vehicle 1 equipped with a detour determination device 10 according to Embodiment 2-1. In the description of FIG. 4, the same step numbers are given to the same processes as those of the description of FIG. 3, the description thereof will be simplified or omitted, and further, different contents will be described.

In FIG. 4, after Step St2, the vehicle 1 acquires the information on the destination of the vehicle 1 which is set before the automated driving starts (for example, in a state before Step St1). The vehicle 1 transmits the information on the time difference before and after a detour in the vehicle 1 which is calculated in Step St2 and the information on the destination of the vehicle 1 to the another vehicle 1T by the inter-vehicle communication in the communication unit 50 (St3a). Further, the communication unit 50 of the vehicle 1 receives the information on the time difference before and after a detour in the another vehicle 1T and the information on the destination of the another vehicle 1T both of which are transmitted from the another vehicle 1T by the inter-vehicle communication (St3a).

After Step St3a, the detour determination unit 14 of the vehicle 1 executes priority degree assignment processing PR2-1 according to Embodiment 2-1 (St9).

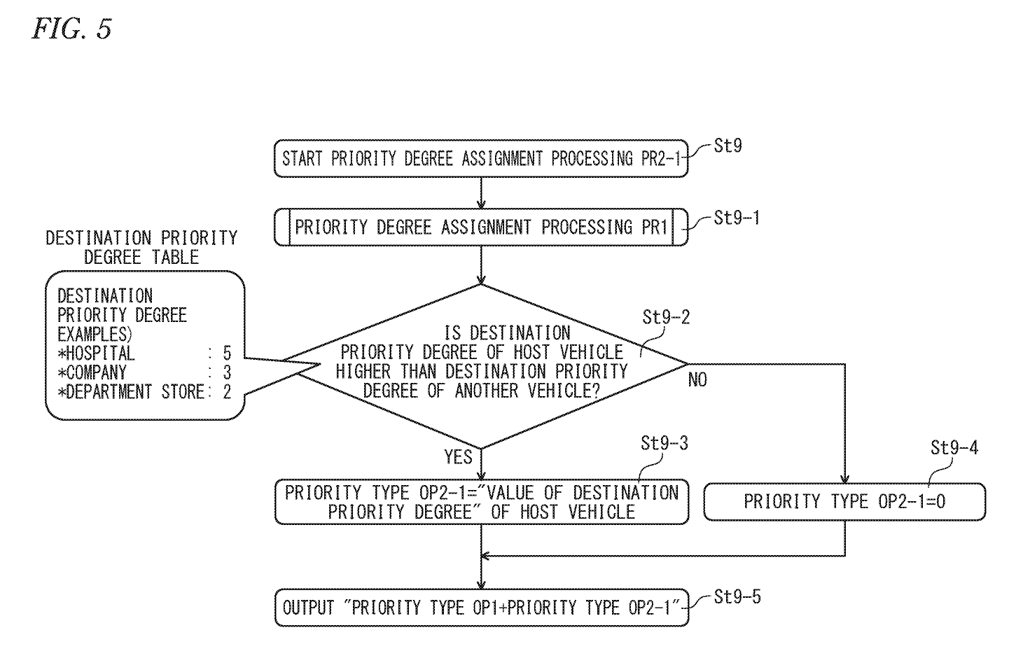

Here, a subroutine of the priority degree assignment processing PR2-1 in Step St9 will be described with reference to FIG. 5. FIG. 5 is a flowchart explaining the subroutine of the priority degree assignment processing PR2-1 in Step St9 of FIG. 4. As described above, the priority degree assignment processing PR2-1 is executed by the detour determination unit 14.

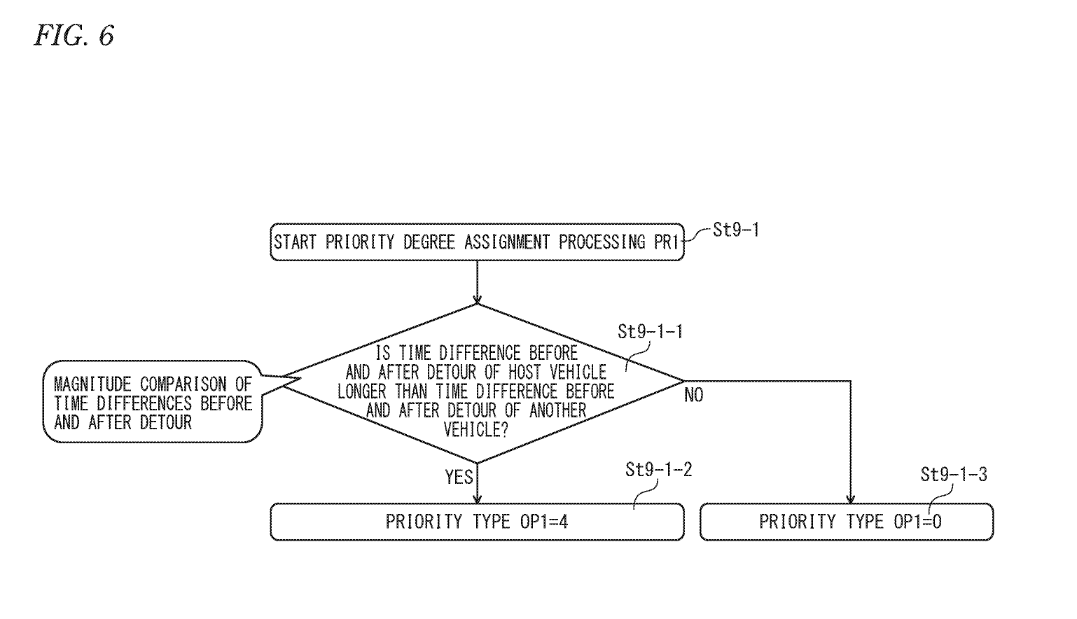

In FIG. 5, the vehicle 1 starts the priority degree assignment processing PR2-1 (St9) and, first, the detour determination unit 14 of the vehicle 1 executes the priority degree assignment processing PR1 for determining the value of the priority type by using the magnitude comparison of the time differences before and after a detour (St9-1). Here, the detail of the priority degree assignment processing PR1 will be described with reference to FIG. 6.

FIG. 6 is a flowchart explaining a subroutine of the priority degree assignment processing PR1 in Step St9-1 of FIG. 5. As described above, the priority degree assignment processing PR1 is executed by the detour determination unit 14.

In FIG. 6, the detour determination unit 14 of the vehicle 1 starts the priority degree assignment processing PR1 (St 9-1) and the detour determination unit 14 of the vehicle 1 determines whether the time difference before and after a detour in the another vehicle 1T is longer than that in the vehicle 1 (host vehicle) by comparing the time difference before and after a detour in the vehicle 1 with the time difference before and after a detour in the another vehicle 1T (St9-1-1).

When it is determined that the time difference before and after a detour in the another vehicle 1T is longer (St9-1-1, YES), the detour determination unit 14 of the vehicle 1 determines to set the priority degree (specifically, the value of a priority type OPT) in the vehicle 1 to “4” (St9-1-2).

On the contrary, when it is determined that the time difference before and after a detour in the vehicle 1 is longer (St9-1-1, NO), the detour determination unit 14 of the vehicle 1 determines to set the priority degree (specifically, the value of the priority type OPT) in the vehicle 1 to “0” (St9-1-3). As a result, the priority degree assignment processing PR1 in the detour determination unit 14 is finished.

After the priority degree assignment processing PR1 of Step St9-1 is executed, the detour determination unit 14 of the vehicle 1 determines whether the priority degree corresponding to the destination of the vehicle 1 (host vehicle) is higher than the priority degree corresponding to the destination of the another vehicle 1T by comparing the priority degree corresponding to the destination of the vehicle 1 with the priority degree corresponding to the destination of the another vehicle 1T (St9-2).

When it is determined that the priority degree corresponding to the destination of the vehicle 1 is higher (St9-2, YES), the detour determination unit 14 of the vehicle 1 determines to set the priority degree (specifically, the value of a priority type OPT-1) in vehicle 1 to “a value of the destination priority degree of the vehicle 1 (host vehicle)” (St9-3). For example, when the destination is “hospital”, the vehicle 1 refers to the destination priority degree table 15 and determines to set the value of the priority type OP2-1 to “5”. This is because it is preferable that the vehicle 1, which is controlled by automated driving to a destination such as a hospital where it is necessary to go as quickly as possible for, for example, a medical treatment for which the time is designated or a visit to a patient or the like, should travel avoiding detouring (in other words, without travelling a long way) as much as possible.

On the contrary, when it is determined that the priority degree corresponding to the destination of the another vehicle 1T is higher (St9-2, NO), the detour determination unit 14 of the vehicle 1 determines to set the priority degree (specifically, the value of the priority type OP2-1) in the vehicle 1to “0” (St9-4). For example, when the destination of the vehicle 1 is “department store” and the destination of the another vehicle 1T is “hospital”, the vehicle 1 determines to set the value of the priority type OP2-1 to “0”.

After Step St9-3 or Step St9-4, the detour determination unit 14 of the vehicle 1 calculates and outputs the sum (that is, added value) of the result of the priority degree assignment processing PR1 (that is, the value of the priority type OP1) executed in Step St9-1 and the value of the priority type OP2-1 (St9-5). Therefore, the priority degree assignment processing PR2-1 in the detour determination unit 14 is finished.

After the Step St9, the detour determination unit 14 of the vehicle 1 determines whether the priority degree in the another vehicle 1T is higher than that in the vehicle 1 (host vehicle) by comparing the priority degree (specifically, the sum of the values of the priority type which is obtained in Step St9-5 described below) of each of the vehicle 1 and the another vehicle 1T which is obtained by the priority degree assignment processing PR2-1 (St4a).

When it is determined that the priority degree in the another vehicle 1T is higher (St4a, YES), the detour determination unit 14 of the vehicle 1 determines to take a detour (that is, in order to take a detour, the vehicle 1 travels to the destination with changing the travelling route which is set in advance in the automated driving) (St5). On the contrary, when it is determined that the priority degree in the vehicle 1 is higher (St4a, NO), the detour determination unit 14 of the vehicle 1 determines to travel along the route as planned without detouring (that is, the vehicle 1 travels to the destination without changing the travelling route which is set in advance in the automated driving) (St7).

As described above, the detour determination device 10 or the vehicle 1 according to Embodiment 2-1 further acquires the information on the destination of the vehicle 1 (host vehicle) as the travelling information of the vehicle 1 (host vehicle). The detour determination device 10 transmits the travelling information of the vehicle 1 (host vehicle) including the information on the destination of the vehicle 1 (host vehicle) to the another vehicle 1T and receives the travelling information of the another vehicle 1T including the information on the destination of the another vehicle 1T. The detour determination device 10 determines the necessity of detouring on the narrow road MTR in accordance with the priority degrees respectively corresponding to the time difference before and after a detour and the destination.

Therefore, the vehicle 1 can transmit and receive the information on the time difference before and after a detour and the information on the destination which are acquired in the respective vehicles (the vehicle 1, the another vehicle 1T) through the inter-vehicle communication. Thus, the vehicle 1 can adaptively determine whether to take a detour or to travel as planned considering not only the circumstances of the road (for example, the required time difference until the arrival at the destinations of the vehicles from the positions thereof) but also the priority degree of the destination. As a result, when it takes a lot more time to detour, the vehicle 1 avoids detouring, thereby supporting smooth travelling of both vehicles. On the other hand, when a place such as a hospital where it is necessary to go quickly due to a reservation for medical treatment or the like is set as the destination, the vehicle 1 can preferentially travel as planned without detouring even though the time difference before and after a detour of the vehicle 1 is higher than that of the another vehicle 1T, so that the convenience of a driver or the like of the vehicle 1 can be improved.

### Embodiment 2-2

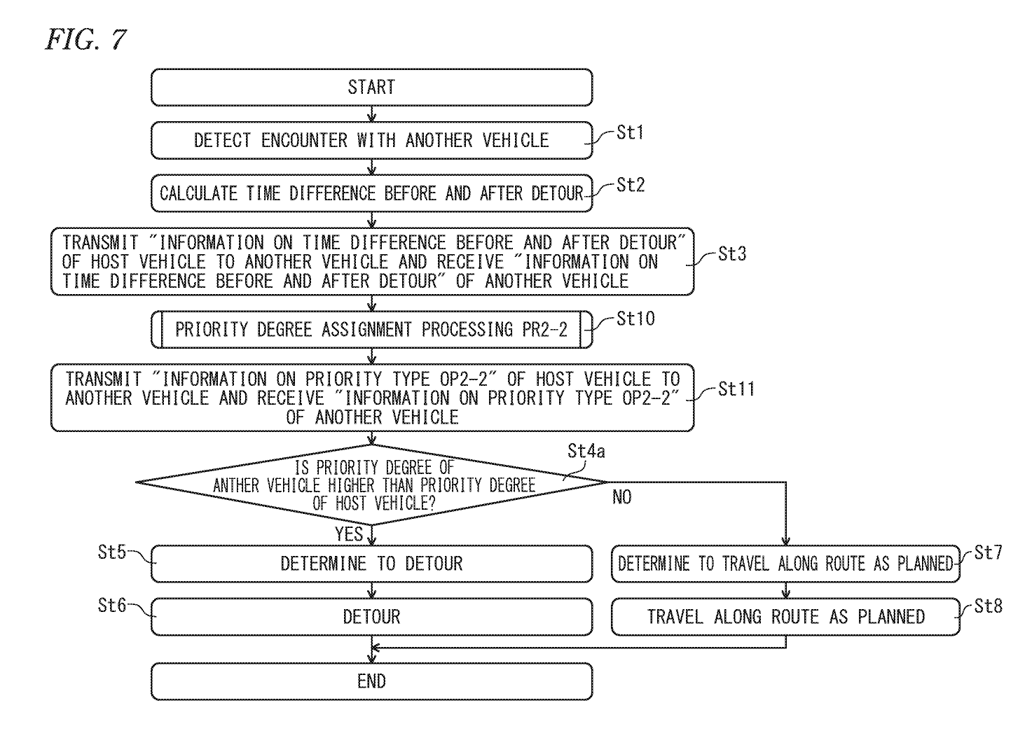

As similar in Embodiment 1, also in Embodiment 2-2, the vehicle 1 encounters the another vehicle 1T on a narrow road during automated driving. Described is an example in which, when the vehicle 1 detects the encounter on the narrow road, the vehicle 1 transmits and receives information on the time difference before and after a detour and information on the priority degree corresponding to the destination to and from the another vehicle 1T by the inter-vehicle communication and determines whether to take a detour or to proceed as planned in accordance with the magnitude of the sum of the priority degrees respectively corresponding to the time differences before and after a detour and the destinations (see FIG. 7).

The internal configurations of the vehicle 1 and the another vehicle 1T according to Embodiment 2-2 are the same as those of the vehicle 1 and the another vehicle 1T according to Embodiment 1. Thus, the same reference signs are denoted to the same components, the description of the same contents is simplified or omitted, and different contents will be described.

FIG. 7 is a flowchart explaining an example of an operation procedure of the vehicle 1 equipped with a detour determination device 10 according to Embodiment 2-2. In the description of FIG. 7, the same step numbers are given to the same processes as those of the description of FIG. 3, the description thereof will be simplified or omitted, and different contents will be described.

In FIG. 7, after Step St3, the detour determination unit 14 of the vehicle 1 executes priority degree assignment processing. PR2-2 according to Embodiment 2-2 (St10).

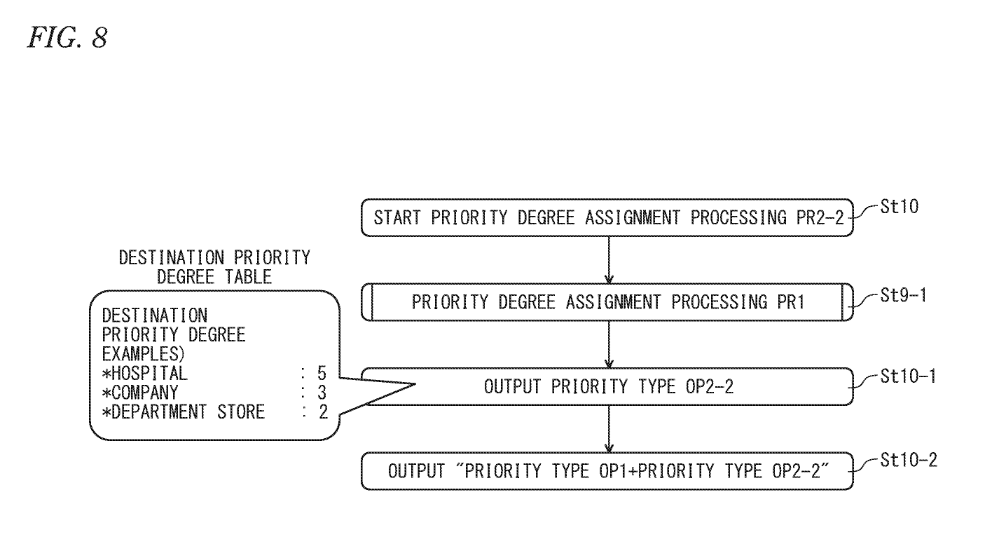

Here, a subroutine of the priority degree assignment processing PR2-2 in Step St10 will be described with reference to FIG. 8. FIG. 8 is a flowchart for explaining the subroutine of the priority degree assignment processing PR2-2 in Step St10 of FIG. 7. As described above, the priority degree assignment processing PR2-2 is executed by the detour determination unit 14.

In FIG. 8, the vehicle 1 starts the priority degree assignment processing PR2-2 (St10) and, first, the detour determination unit 14 of the vehicle 1 executes the priority degree assignment processing PR1 for determining the value of the priority type by using the magnitude comparison of the time differences before and after a detour (St9-1). Since the detail of the priority degree assignment processing PR1 in Step St9-1 has been described with reference to FIG. 6, the description thereof is omitted here.

After the priority degree assignment processing PR1 in Step St9-1 is executed, the vehicle 1 determines a priority degree corresponding to the destination of the vehicle 1 (that is, a value of a priority type OP2-2 which is a parameter corresponding to the type of the destination registered in the destination priority degree table 15) with reference to the destination priority degree table 15 and outputs the priority degree (St10-1).

After Step St10-1, the detour determination unit 14 of the vehicle 1 calculates the sum (that is, an added value) of the result (that is, the value of the priority type OP1) of the priority degree assignment processing PR1 executed in Step St9-1 and the value of the priority type OP2-2 output in the Step St10-1 and outputs the calculated sum (St10-2). Therefore, the priority degree assignment processing PR2-2 in the detour determination unit 14 is finished.

After Step St10, the vehicle 1 transmits the information on the priority type OP2-2 corresponding to the vehicle 1 which is determined in the Step St10-1 to the another vehicle 1T through the inter-vehicle communication in the communication unit 50 (St11). Further, in the vehicle 1, the communication unit 50 receives the information of the priority type OP2-2 in the another vehicle 1T which is transmitted from the another vehicle 1T through the inter-vehicle communication (St11). When the communication unit 50 of the vehicle 1 receives the information on the priority type OP2-2 in the another vehicle 1T which is transmitted from the another vehicle 1T through the inter-vehicle communication, the detour determination unit 14 of the vehicle 1 calculates the sum (that is, the added value) of the priority type OP1 and the priority type OP2-2 in the another vehicle 1T Further, the detour determination unit 14 of the vehicle 1 calculates the sum (that is, the added value) of the priority type OP1 and the priority type OP2-2 in the vehicle 1.

After Step St11, the detour determination unit 14 of the vehicle 1 determines whether the priority degree in the another vehicle 1T is higher than that in the vehicle 1 (host vehicle) by comparing the calculated priority degrees (specifically, the sums of the values of the priority types obtained in Step St10-2) of the vehicle 1 and the another vehicle 1T (St4a). Since the processing after Step St4a is the same as the corresponding processing in FIG. 3 or 4, the description thereof will be omitted.

As described above, the detour determination device 10 or the vehicle 1 according to Embodiment 2-2 further acquires the information on the destination of the vehicle 1 (host vehicle) as the travelling information of the vehicle 1 (host vehicle). The detour determination device 10 transmits the travelling information of the vehicle 1 (host vehicle) including the information on the priority degree corresponding to the destination (for example, the value of the priority type OP2-2) of the vehicle 1 (host vehicle) to the another vehicle 1T and receives the travelling information of the another vehicle 1T including the information on the priority degree corresponding to the destination (for example, the value of the priority type OP2-2) of the vehicle 1T. The detour determination device 10 determines the necessity of detouring on the narrow road MTR in accordance with the priority degrees respectively corresponding to the time difference before and after a detour and the destination.

Therefore, since the vehicle 1 can transmit and receive the information on the time difference before and after a detour and the information on the priority degree corresponding to the destination both of which are acquired in the respective vehicles (the vehicle 1, the another vehicle 1T) through the inter-vehicle communication, it is possible to omit transmission and reception of the information on the destination, which is a highly private matter. Therefore, it is possible to effectively prevent personal information of a driver or the like of the vehicle from being known to the other party. Further, the vehicle 1 can adaptively determine whether to take a detour or to travel as planned considering not only the circumstances of the road (for example, the required time difference until the arrival at the destinations of the vehicles from the positions thereof) but also the priority degree of the destination. As a result, when it takes a lot more time to detour, the vehicle 1 avoids detouring, thereby supporting smooth travelling of both vehicles. Further, when a place such as a hospital where it is necessary to go quickly due to a reservation for medical treatment or the like is set as the destination the vehicle 1 can preferentially travel as planned without detouring, even though the time difference before and after a detour of the vehicle 1 is higher than that of the another vehicle 1T, so that the convenience of a driver or the like of the vehicle 1 can be improved.

### Embodiment 3

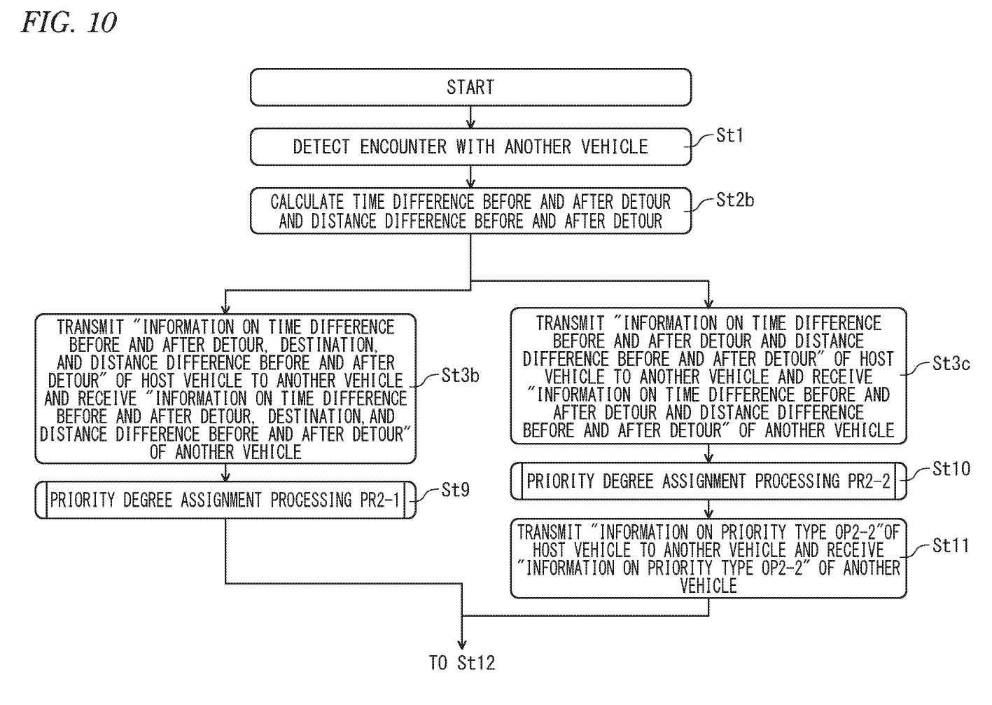

As similar in Embodiment 1, also in Embodiment 3, the vehicle 1 encounters the another vehicle 1T on a narrow road during automated driving. Described is an example in which, when the vehicle 1 detects the encounter on the narrow road, the vehicle 1 transmits and receives, in addition to those of Embodiment 2-1 or Embodiment 2-2, information on a distance difference before and after a detour to and from the another vehicle 1T by the inter-vehicle communication and determines whether to take a detour or to proceed as planned in accordance with the magnitude of the sum of the priority degrees respectively corresponding to the time differences before and after a detour, the destinations, and the distance differences before and after a detour (see FIG. 10).

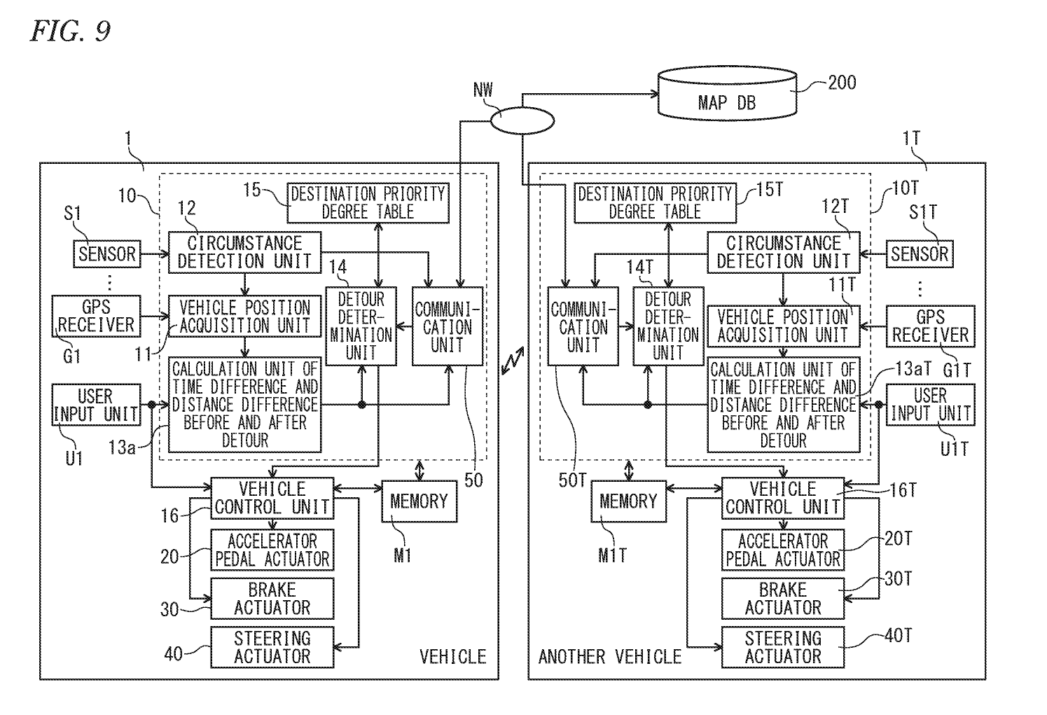

The internal configurations of the vehicle 1 and the another vehicle 1T according to Embodiment 3 are the same as those of the vehicle 1 and the another vehicle 1T according to Embodiment 1, except for some configurations. Thus, the same reference signs are denoted to the same components, the description of the same contents is simplified or omitted, and different contents will be described (see FIG. 9).

FIG. 9 is a block diagram for illustrating an internal configuration example of each of the vehicle 1 and the another vehicle 1T equipped with the detour determination device according to Embodiment 3. In the description of each configuration in FIG. 9, the same reference signs are denoted to the same components as the corresponding components in FIG. 1, the description thereof is simplified or omitted, and different contents will be described.

A calculation unit of time difference and distance difference before and after a detour 13a as an example of an acquisition unit calculates, using the detection results from the plurality of sensors S1, a distance difference before and after a detour indicating a difference between a first required distance to travel from the narrow road where the vehicle 1 encounters the another vehicle 1T to the destination of the vehicle 1 (host vehicle) with detouring and a second required distance to proceed to the destination as planned without detouring as travelling information of the vehicle 1. In addition, the calculation unit of time difference and distance difference before and after a detour 13a outputs the information on the calculated distance difference before and after a detour to the detour determination unit 14 and the communication unit 50.

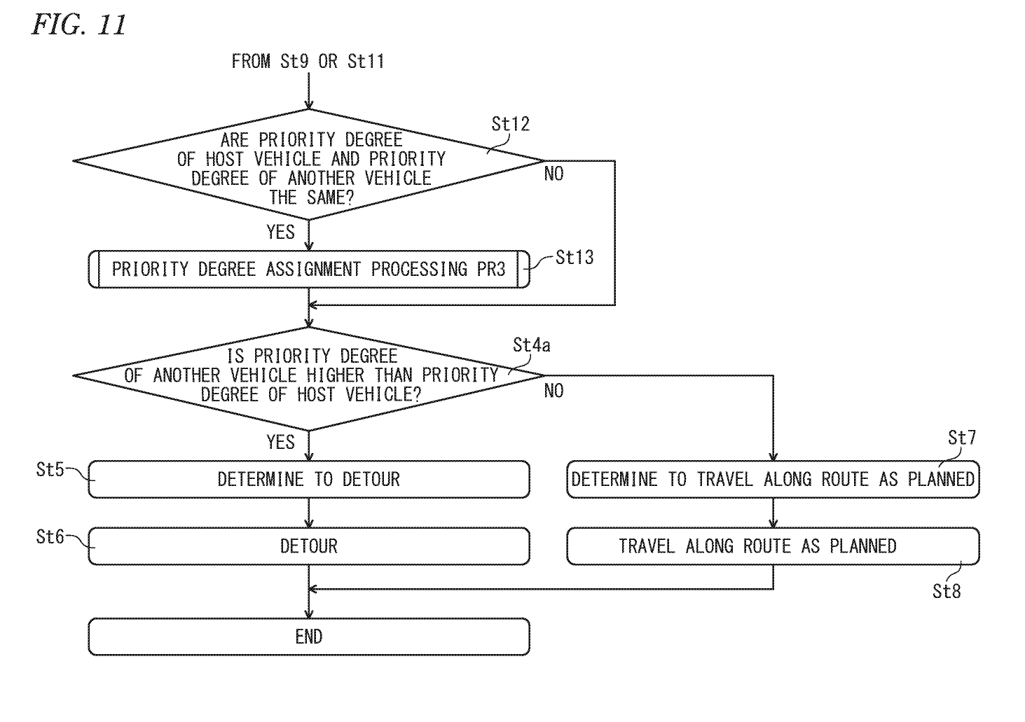

FIGS. 10 and 11 are flowcharts for explaining examples of an operation procedure of the vehicle 1 equipped with the detour determination device 10 according to Embodiment 3, In the descriptions of FIGS. 10 and 11, the same step numbers are given to the same processes as those of the description of FIG. 3, 4 or 7, the description thereof will be simplified or omitted, and different contents will be described.

In FIG. 10, the vehicle 1 detects the encounter with the another vehicle 1T on the narrow road MTR in Step St1, and the calculation unit of time difference and distance difference before and after a detour 13a calculates, using the detection results from the plurality of sensors S1, a time difference before and after a detour indicating a difference between a first required time to travel from the narrow road where the vehicle 1 encounters the another vehicle 1T to the destination of the vehicle 1 (host vehicle) with detouring and a second required time to proceed to the destination as planned without detouring as the travelling information of the vehicle 1 (St2b). Further, the calculation unit of time difference and distance difference before and after a detour 13a calculates, using the detection results from the plurality of sensors S1, the distance difference before and after a detour indicating the difference between the first required distance to travel from the narrow road where the vehicle 1 encounters the another vehicle 1T to the destination of the vehicle 1 (host vehicle) with detouring and the second required distance to proceed to the destination as planned without detouring as the travelling information of the vehicle 1 (St2b).

After Step St2b, the vehicle 1 executes either “processing of Step St3b and Step St9” or “processing of Steps St3c, St10 and St11”.

For example, the vehicle 1 acquires the information on the destination of the vehicle 1 which is set before the start of the automated driving (for example, a state before Step St1). The communication unit 50 of the vehicle 1 transmits the information on the time difference before and after a detour and the distance difference before and after a detour in the vehicle 1 both of which are calculated in Step St2b and the information on the destination of the vehicle 1 to the another vehicle 1T through the inter-vehicle communication (St3b). Also, the communication unit 50 of the vehicle 1 receives the information on the time difference before and after a detour and the distance difference before and after a detour in the another vehicle 1T and the information on the destination of the another vehicle 1T which are transmitted from the another vehicle 1T through the inter-vehicle communication (St3b). Since the processing of Step St9 (that is, priority degree assignment processing PR2-1) after Step St3b has been described in Embodiment 2-1, the description thereof is omitted here.

Further, for example, the vehicle 1 acquires the information on the destination of the vehicle 1 which is set before the start of automated driving (for example, a state before Step St1. The communication unit 50 of the vehicle 1 transmits the information on the time difference before and after a detour and the distance difference before and after a detour in the vehicle 1 which are calculated in Step St2b to the another vehicle 1T through the inter-vehicle communication (St3c). Further, the communication unit 50 of the vehicle 1 receives the information on the time difference before and after a detour and the distance difference before and after a detour in the another vehicle 1T which are transmitted from the another vehicle 1T through the inter-vehicle communication (St3c). Since the processing of Steps St10 and St11 (that is, transmission and reception processing of the values of the priority degree assignment processing PR2-2 and the priority type OP2-2 through the inter-vehicle communication) after Step St3c has been described in Embodiment 2-2, the description thereof is omitted here.

In FIG. 11, the detour determination unit 14 of the vehicle 1 determines whether the calculated priority degrees of the vehicle 1 and the another vehicle 1T (specifically, the sums of the values of the priority types which are calculated in Step St9-5 (see FIG. 5) or Step St11 (that is, “priority type OP1+priority type OP2-1” or “priority type OP1+priority type OP2-2”)) are the same (St12). When it is determined that the sums of the values of the priority types in the vehicle 1 and the another vehicle 1T are not the same (St12, NO), processing of the vehicle 1 proceeds to Step St4a.

On the contrary, when it is determined that the sums of the values of the priority types in the vehicle 1 and the another vehicle 1T are the same (St12, YES), the detour determination unit 14 of the vehicle 1 executes the priority degree assignment processing PR3 according to Embodiment 3 (St13).

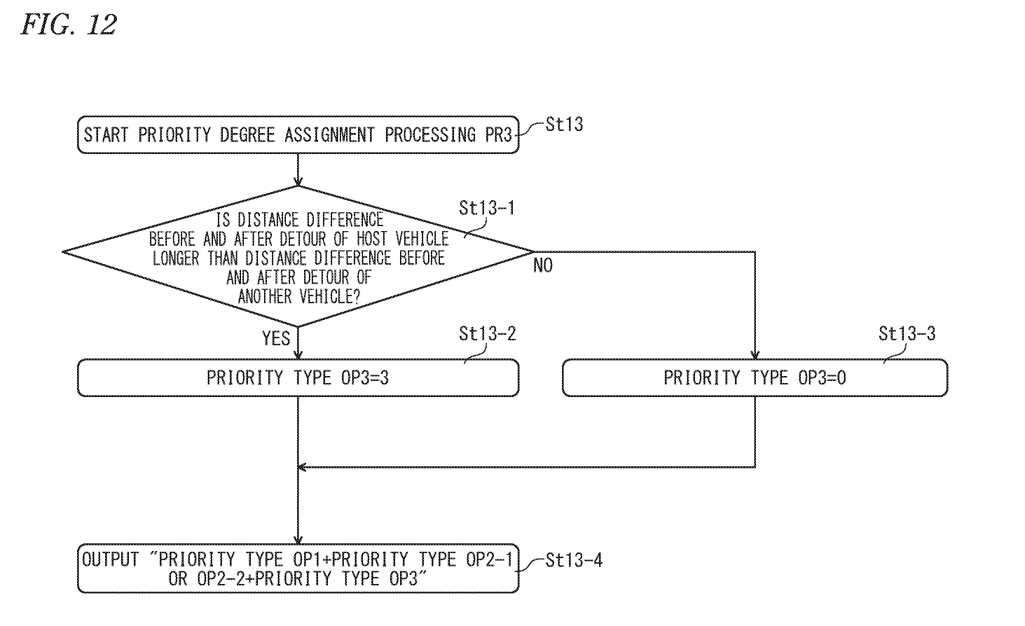

Here, a subroutine of the priority degree assignment processing PR3 of Step St13 will be described with reference to FIG. 12. FIG. 12 is a flowchart for explaining a subroutine of the priority degree assignment processing PR3 in Step St13 of FIG. 11. As described above, the priority degree assignment processing PR3 is executed by the detour determination unit 14.

In FIG. 12, the detour determination unit 14 of the vehicle 1 starts the priority degree assignment processing PR3 (St13) and the detour determination unit 14 of the vehicle 1 determines whether the distance difference before and after a detour in the another vehicle 1T is longer than that in the vehicle 1 (host vehicle) by comparing the distance difference before and after a detour in the vehicle 1 with the distance difference before and detour in the another vehicle 1T (St13-1).

When it is determined that the distance difference before and after a detour in the another vehicle 1T is longer (St13-1, YES), the detour determination unit 14 of the vehicle 1 determines that the priority degree (specifically, the value of the priority type OP3) in the vehicle 1 is set to “3” (St13-2). This is to avoid the detour as much as possible in order to improve the convenience of a driver or the like of the vehicle 1 when the distance difference before and after a detour is longer (that is, when the vehicle takes a detour, the distance to the destination becomes a lot longer).

On the contrary, when it is determined that the distance difference before and after a detour in the vehicle 1 is longer (St13-1. NO), the detour determination unit 14 of the vehicle 1 determines that the priority degree (specifically, the value of the priority type OP3) in the vehicle 1 is set to “0” (St13-2). This is because when the distance difference before and after a detour does not become longer (that is, even when the vehicle takes a detour, the distance to the destination does not significantly change), it is considered that this does not cause inconvenience to a driver or the like of the vehicle 1 even though the vehicle takes a detour.

After Step St13-2 or Step St13-3, the vehicle 1 calculates the sum of the value of the priority type OP1, the value of the priority type OP2-1 or the priority type OP2-2 and the value of the priority type OP3 (that is, the added value) and outputs the calculated value (St13-4). Therefore, the priority degree assignment processing PR3 in the detour determination unit 14 is finished.

After the priority degree assignment processing PR3 of Step St13, the processing of the vehicle 1 proceeds to Step St4a. As the processing after Step St4a has been described in, for example, FIG. 4, the description thereof is omitted here.

As described above, the detour determination device or the vehicle 1 according to Embodiment 3 calculates the distance difference before and after a detour indicating the difference between the first required distance to travel from the narrow road MTR to the destination of the vehicle 1 (host vehicle) with detouring and the second required distance to proceed to the destination without detouring as the travelling information of the vehicle 1 (host vehicle). The detour determination device 10 transmits the travelling information of the vehicle 1 (host vehicle) including the information on the distance difference before and after a detour (an example of the detouring distance difference) of the vehicle 1 (host vehicle) to the another vehicle 1T through the inter-vehicle communication and the detour determination device 10 receives the travelling information of the another vehicle 1T including the information on the distance difference before and after a detour of the another vehicle 1T through the inter-vehicle communication. The detour determination device 10 determines the necessity of detouring on the narrow road MTR in accordance with the priority degrees is respectively corresponding to the time difference before and after a detour, the destination, and the distance difference before and after a detour.

Therefore, the vehicle can also transmit and receive the information on the distance differences before and after a detour acquired in the respective vehicles (the vehicle 1, the another vehicle 1T) through the inter-vehicle communication. Thus, in addition to the effects according to Embodiment 2-1 or Embodiment 2-2, the vehicle 1 can adaptively determine whether to take a detour or to travel as planned considering not only the circumstances of the road (for example, the required time difference until the arrival at the destinations of the vehicles from the positions thereof) and the priority degree of the destination but also the distance difference due to a detour. As a result, when the distance becomes a lot longer when the vehicle takes a detour, the vehicle 1 avoids detouring, thereby supporting smooth travelling of both vehicles. Further, since it is possible to determine whether to take a detour in accordance with the distance difference before and after a detour even when the sums of priority degrees in the vehicle 1 and the another vehicle 1T are the same even when the operation of Embodiment 2-1 or Embodiment 2-2 is executed, it is possible to support smooth travelling of both vehicles.

Hereinbefore, various embodiments are described with reference to the drawings. However, it goes without saying that the present disclosure is not limited to such examples. Those skilled in the art will appreciate that various changes, modifications, substitutions, additions, deletions, and equivalent examples can be conceived within the scope described in the claims and those skilled in the art will understand that those are also within the technical scope of the present disclosure. Further, constituent elements in the various embodiments described above may arbitrarily be combined within the scope not deviating from the gist of the invention.

In each embodiment described above, the communication unit 50 of the vehicle 1 may transmit and receive the data or the information to and from the communication unit 50T of the another vehicle 1T by using, for example, wireless communication between the vehicle 1 and a known infrastructure (for example, communication via an access point provided as an infrastructure and communication via a server device (not illustrated) which controls the travelling direction of the another vehicle 1T) without being limited to the inter-vehicle communication with the communication unit 50T of the another vehicle 1T.

Similarly, the communication unit 50T of the another vehicle 1T may transmit and receive the data or the information to and from the communication unit 50 of the vehicle 1 by using, for example, wireless communication between the another vehicle 1T and a known infrastructure (for example, communication via an access point provided as an infrastructure and communication via a server device (not illustrated) which controls the travelling direction of the vehicle 1) without being limited to the inter-vehicle communication with the communication unit 50 of the vehicle 1.

In Embodiment 3 described above, the processing of Step St12 may be omitted.

In this case, the priority degree assignment processing PR3 of Step St13 is executed after the processing of Step St9 or the processing of Step St11. That is, the information on the distance difference before and after a detour may be used for determining whether to take a detour, irrespective of whether the sums of the values of the priority types OP1 and the values of the priority types OP2-1 or the priority types OP2-2 are the same.

In the various embodiments described above, the information transmitted and received between the vehicle 1 and the another vehicle 1T through the inter-vehicle communication may include the following information. For example, information on whether a reservation (for example, reservations for hospitals, hairdressers, photo halls, restaurants, and the like) is made in relation with a destination, information indicating whether it is an emergency vehicle such as an ambulance or a patrol car at work, or information on a motive (for example, a plan to go to the hospital for medical treatment) for moving to a destination may correspond. As a result, the vehicle 1 can comprehensively adaptively determine the necessity of detouring by considering various pieces of the information described above in addition to the information considered in the various embodiments.

In Embodiment 2-1 or Embodiment 2-2 described above, when the vehicle 1 determines the necessity of detouring, only the value of the priority degree corresponding to the destination may be used without considering the information on the time differences before and after a detour in the vehicle 1 and the another vehicle 1T.

In Embodiment 3 described above, when the vehicle 1 determines the necessity of detouring, the information on the time differences before and after a detour and the distance differences before and after a detour in the vehicle 1 and the another vehicle 1T may be considered and the priority degrees according to the destination may not be considered.

The present disclosure is useful as a detour determination device, a detour determination method, and a program therefor which support smooth travelling of two vehicles by adaptively making the two vehicles determining whether to take a detour or to travel as planned when the two vehicles encounter on a narrow road having a travelling width for only one vehicle.

While various embodiments have been described herein above, it is to be appreciated that various changes in form and detail may be made without departing from the spirit and scope of the invention(s) presently or hereinafter claimed.

This application is based on and claims priority from Japanese Patent Application No. 2018-066231 filed on Mar. 29, 2018, the entire contents of which are incorporated herein by reference.

1. A detour determination device, comprising:
a detector, which, in operation, detects whether another vehicle exists on a route to a destination;
an acquirer, which, in operation, acquires travelling information of a host vehicle;
a communicator, which, in operation, transmits the travelling information of the host vehicle to the another vehicle and receives travelling information from the another vehicle, when the another vehicle exists; and
a determiner, which, in operation, determines necessity of detouring of the host vehicle in accordance with the travelling information of the host vehicle and the received travelling information of the another vehicle.

2. The detour determination device according to claim 1,
wherein the determiner, in operation, outputs a travelling instruction based on a determination result of the necessity of detouring to a vehicle controller configured to control driving of the host vehicle.

3. The detour determination device according to claim 1,
wherein the acquirer, in operation, calculates a detouring time difference of the host vehicle indicating a difference between a first required time in a case in which the host vehicle travels to the destination with detouring and a second required time in a case in which the host vehicle travels to the destination without detouring,
wherein the communicator, in operation, transmits the travelling information of the host vehicle including information on the detouring time difference of the host vehicle to the another vehicle and receives the travelling information of the another vehicle including information on a detouring time difference of the another vehicle, and
wherein the determiner, in operation, determines the necessity of detouring in accordance with the detouring time difference of the host vehicle and the detouring time difference of the another vehicle.

4. The detour determination device according to claim 3,
wherein the acquirer, in operation, further acquires information on the destination of the host vehicle,
wherein the communicator, in operation, transmits the travelling information of the host vehicle including the information on the destination of the host vehicle to the another vehicle and receives the travelling information of the another vehicle including information on a destination of the another vehicle, and
wherein the determiner, in operation, determines the necessity of detouring in accordance with priority degrees respectively corresponding to the detouring time differences and the destinations.

5. The detour determination device according to claim 4,
wherein the priority degrees respectively corresponding to the detouring time differences and the destinations are decided based on a first priority type and a second priority type, the first priority type being determined by a magnitude comparison between the detouring time difference of the host vehicle and the detouring time difference of the another vehicle, and the second priority type being determined by a magnitude comparison between a priority degree assigned to a kind of the destination of the host vehicle and a priority degree assigned to a kind of the destination of the another vehicle.

6. The detour determination device according to claim 4,
wherein the acquirer, in operation, calculates a detouring distance difference indicating a difference between a first required distance in a case in which the host vehicle travels to the destination with detouring and a second required distance in a case in which the host vehicle travels to the destination without detouring,
wherein the communicator, in operation, transmits the travelling information of the host vehicle including information on the detouring distance difference of the host vehicle to the another vehicle and receives the travelling information of the another vehicle including information on a detouring distance difference of the another vehicle, and
wherein the determiner, in operation, determines the necessity of detouring in accordance with priority degrees respectively corresponding to the detouring time differences, the destinations, and the detouring distance differences.

7. The detour determination device according to claim 3,
wherein the acquirer, in operation, further acquires information on the destination of the host vehicle,
wherein the communicator transmits the travelling information of the host vehicle including information on a priority degree corresponding to the destination of the host vehicle to the another vehicle and receives the travelling information of the another vehicle including information on a priority degree corresponding to the destination of the another vehicle, and
wherein the determiner, in operation, determines the necessity of detouring in accordance with the priority degree corresponding to the detouring time difference and the priority degree corresponding to the destination.

8. The detour determination device according to claim 7,
wherein the priority degree corresponding to the detouring time difference is determined by a magnitude comparison between the detouring time difference of the host vehicle and the detouring time difference of the another vehicle, and
wherein the priority degree corresponding to the destination is a priority degree assigned to a kind of the destination.

9. The detour determination device according to claim 7,
wherein the acquirer, in operation, calculates a detouring distance difference indicating a difference between a first required distance in a case in which the host vehicle travels to the destination with detouring and a second required distance in a case in which the host vehicle travels to the destination without detouring,
wherein the communicator, in operation, transmits the travelling information of the host vehicle including information on the detouring distance difference of the host vehicle to the another vehicle and receives the travelling information of the another vehicle including information on a detouring distance difference of the another vehicle, and
wherein the determiner, in operation, determines the necessity of detouring in accordance with priority degrees respectively corresponding to the detouring time differences, the destinations, and the detouring distance differences.

10. A detour determination method for a detour determination device, comprising:
detecting whether another vehicle exists on a route to a destination;
acquiring travelling information of a host vehicle;
transmitting the travelling information of the host vehicle to the another vehicle and receiving travelling information from another vehicle, when the another vehicle exists; and
determining necessity of detouring of the host vehicle in accordance with the travelling information of the host vehicle and the received travelling information of the another vehicle.

11. A non-transitory computer readable medium having a set of computer readable instruction that, when executed, cause an electronic device to:
detect whether another vehicle exists on a route to a destination;
acquire travelling information of a host vehicle;
transmit the travelling information of the host vehicle to the another vehicle and receive travelling information from another vehicle, when the another vehicle exists; and
determine necessity of detouring of the host vehicle in accordance with the travelling information of the host vehicle and the received travelling information of the another vehicle.
